(19) United States
(12) Patent Application Publication
(10) Pub. No.: US 2026/0184241 A1
(43) Pub. Date: Jul. 2, 2026

(54) LATCH DEVICE AND VEHICLE SEAT

(71) Applicants: TS TECH CO., LTD., Asaka-shi (JP); HONDA MOTOR CO., LTD., Tokyo (JP)

(72) Inventors: Takahiro INABA, Tochigi (JP); Masaru TAKAGI, Tochigi (JP); Naomichi FUKUDA, Tochigi (JP); Manabu MATSUMOTO, Tokyo (JP)

(21) Appl. No.: 19/419,861

(22) Filed: Dec. 15, 2025

(30) Foreign Application Priority Data
Dec. 26, 2024 (JP) 2024-231392

(51) Int. Cl. B60N 2/36

(52) U.S. Cl. CPC B60N 2/366

(57) ABSTRACT

A latching device configured to lock or unlock by engaging with or disengaging from a striker includes: a base member having an entry groove that the striker can enter; a latch pivotably supported on the base member and having an engagement key part configured to engage with the striker that has entered the entry groove; and a movement restraining part provided on the base member and disposed across the entry groove.

### TECHNICAL FIELD

The present invention relates to a latching device and a vehicle seat provided with the latching device.

### BACKGROUND ART

JP2015-163506A discloses a latching device for vehicles capable of engaging with and disengaging from a rod-like portion of a striker fixed to a vehicle main body to lock and unlock the latching device. This latching device for a vehicle includes a casing having an insertion groove for allowing the rod-like portion to be inserted thereinto, and a latch received in and rotatably supported by the casing and having a hook-like portion engageable with the rod-like portion. The casing includes a resinous casing rotatably supporting the latch and a reinforcement plate in which the insertion groove is formed, and the resinous casing and the reinforcement plate are superposed one on another.

The latching device disclosed inJP2015-163506Ais fixed to a side portion of one of the side frames, which are parts of the frame of the vehicle seat constituting the seatback, via a bracket. Therefore, if a large load for pulling the seat belt hard is applied to the side frame, the latch is urged to move relative to the striker. Thus, it has been desired to restrain the relative movement between the latch and the striker so that the latch does not move relative to the striker.

### SUMMARY OF THE INVENTION

In view of the foregoing background, an object of the present invention is to provide a latching device capable of restraining the relative movement between the latch and the striker and a vehicle seat provided with such a latching device.

To achieve the above object, one aspect of the present invention provides a latching device (40) configured to lock or unlock by engaging with or disengaging from a striker (37), the latching device comprising: a base member (42) having an entry groove (41) that the striker can enter; a latch (46) pivotably supported on the base member and having an engagement key part (47) configured to engage with the striker that has entered the entry groove; and a movement restraining part (50) provided on the base member and disposed across the entry groove.

According to this aspect, when the latch engaging with the striker moves relative to the striker, the striker comes into contact with the movement restraining part crossing the entry groove. Thereby, the movement of the striker relative to the latch is restrained by the movement restraining part.

In the above aspect, the movement restraining part may be disposed to cross an engagement part (37a) between the engagement key part of the latch and the striker.

According to this aspect, when the latch engaging with the striker moves relative to the striker, the striker reliably comes into contact with the movement restraining part crossing the engagement part. Thereby, the relative movement between the latch and the striker is restrained.

In the above aspect, the movement restraining part is fixed to the base member by a pair of first fixing parts (52A) extending in parallel with an extension direction of the entry groove and facing each other and a second fixing part (52B) extending in a direction intersecting the extension direction of the entry groove.

According to this aspect, it is easy to improve the stiffness of the movement restraining part against the load during the relative movement of the striker.

In the above aspect, a gap (56) may be formed between each of the first fixing parts and the second fixing part, and the gap may be configured such that the latch is viewable from outside through the gap.

According to this aspect, the state of the latch with respect to the striker (engaged state or disengaged state) can be visually recognized.

In the above aspect, a length (L1) of each of the first fixing part in an extension direction thereof may be longer than a length (L2) of the second fixing part in an extension direction thereof.

According to this aspect, the stiffness of each of the first fixing parts which are at positions sandwiching the striker engaged by the latch can be made high compared to the stiffness of the second fixing part, and the relative movement between the latch and the striker can be restrained more reliably.

In the above aspect, the base member may be provided with multiple base fixing parts (43) for fixing the base member to a frame member (35), and the second fixing part of the movement restraining part may be disposed between the multiple base fixing parts.

According to this aspect, since the second fixing part is fixed to a part of the base member between the multiple base fixing parts, the support stiffness of the second fixing part is improved.

In the above aspect, the base member may be provided with a flange (45) along an edge of the entry groove, and the movement restraining part may be provided with a wall portion (53) along the flange.

According to this aspect, the stiffness of the edge part of the entry groove of the base member is increased by the presence of the flange, and moreover, the stiffness of the movement restraining part is increased by the presence of the wall portion along the flange.

In the above aspect, the base member may be provided with two base fixing parts (43) for fixing the base member to the frame member (35), one of the first fixing parts may be disposed to be aligned with one of the base fixing parts in the extension direction of the entry groove, and another of the first fixing parts may be disposed to be aligned with another of the base fixing parts in the extension direction of the entry groove.

According to this aspect, since each of the first fixing parts is disposed to be aligned with the corresponding base fixing part in the extension direction of the entry groove, the support stiffness of the both first fixing parts is improved.

Also, to achieve the above object, one aspect of the present invention provides a vehicle seat (1), comprising: a seat cushion (4) provided on a body (3) of a vehicle; a seatback (5) supported on the body to be pivotable about a pivot axis extending in a width direction of the vehicle; and the latching device (40) mentioned above, wherein preferably, the latching device is disposed on one of side portions of the seatback and the striker is fixed to the body.

According to this aspect, a vehicle seat provided with a latching device capable of restraining the relative movement between the latch and the striker can be provided.

In the above aspect, the movement restraining part may be disposed on an outer side of the base member in the width direction.

When a large load is applied to the seatback, the latching device moves toward the center in the width direction of the seatback, and the striker undergoes a relative movement outward in the width direction. At this time, according to this aspect, the striker undergoing the relative movement outward in the width direction comes into contact with the movement restraining part, whereby the movement of the striker relative to the latch is restrained by the movement restraining part.

### EFFECT OF THE INVENTION

One aspect of the present invention provides a latching device (40) configured to lock or unlock by engaging with or disengaging from a striker (37), the latching device comprising: a base member (42) having an entry groove (41) that the striker can enter; a latch (46) pivotably supported on the base member and having an engagement key part (47) configured to engage with the striker that has entered the entry groove; and a movement restraining part (50) provided on the base member and disposed across the entry groove.

According to this aspect, when the latch engaging with the striker moves relative to the striker, the striker comes into contact with the movement restraining part crossing the entry groove. Thereby, the movement of the striker relative to the latch is restrained by the movement restraining part.

In the above aspect, the movement restraining part may be disposed to cross an engagement part (37a) between the engagement key part of the latch and the striker.

According to this aspect, when the latch engaging with the striker moves relative to the striker, the striker reliably comes into contact with the movement restraining part crossing the engagement part. Thereby, the relative movement between the latch and the striker is restrained.

In the above aspect, the movement restraining part is fixed to the base member by a pair of first fixing parts (52A) extending in parallel with an extension direction of the entry groove and facing each other and a second fixing part (52B) extending in a direction intersecting the extension direction of the entry groove.

According to this aspect, it is easy to improve the stiffness of the movement restraining part against the load during the relative movement of the striker.

In the above aspect, a gap (56) may be formed between each of the first fixing parts and the second fixing part, and the gap may be configured such that the latch is viewable from outside through the gap.

According to this aspect, the state of the latch with respect to the striker (engaged state or disengaged state) can be visually recognized.

In the above aspect, a length (L1) of each of the first fixing part in an extension direction thereof may be longer than a length (L2) of the second fixing part in an extension direction thereof.

According to this aspect, the stiffness of each of the first fixing parts which are at positions sandwiching the striker engaged by the latch can be made high compared to the stiffness of the second fixing part, and the relative movement between the latch and the striker can be restrained more reliably.

In the above aspect, the base member may be provided with multiple base fixing parts (43) for fixing the base member to a frame member (35), and the second fixing part of the movement restraining part may be disposed between the multiple base fixing parts.

According to this aspect, since the second fixing part is fixed to a part of the base member between the multiple base fixing parts, the support stiffness of the second fixing part is improved.

In the above aspect, the base member may be provided with a flange (45) along an edge of the entry groove, and the movement restraining part may be provided with a wall portion (53) along the flange.

According to this aspect, the stiffness of the edge part of the entry groove of the base member is increased by the presence of the flange, and moreover, the stiffness of the movement restraining part is increased by the presence of the wall portion along the flange.

In the above aspect, the base member may be provided with two base fixing parts (43) for fixing the base member to the frame member (35), one of the first fixing parts may be disposed to be aligned with one of the base fixing parts in the extension direction of the entry groove, and another of the first fixing parts may be disposed to be aligned with another of the base fixing parts in the extension direction of the entry groove.

According to this aspect, since each of the first fixing parts is disposed to be aligned with the corresponding base fixing part in the extension direction of the entry groove, the support stiffness of the both first fixing parts is improved.

Also, to achieve the above object, one aspect of the present invention provides a vehicle seat (1), comprising: a seat cushion (4) provided on a body (3) of a vehicle; a seatback (5) supported on the body to be pivotable about a pivot axis extending in a width direction of the vehicle; and the latching device (40) mentioned above, wherein preferably, the latching device is disposed on one of side portions of the seatback and the striker is fixed to the body.

According to this aspect, since each of the first fixing parts is disposed to be aligned with the corresponding base fixing part in the extension direction of the entry groove, the support stiffness of the both first fixing parts is improved.

In the above aspect, the movement restraining part may be disposed on an outer side of the base member in the width direction.

When a large load is applied to the seatback, the latching device moves toward the center in the width direction of the seatback, and the striker undergoes a relative movement outward in the width direction. At this time, according to this aspect, the striker undergoing the relative movement outward in the width direction comes into contact with the movement restraining part, whereby the movement of the striker relative to the latch is restrained by the movement restraining part.

### BRIEF DESCRIPTION OF THE DRAWINGS

FIG. 1 is a perspective view of a vehicle seat according to an embodiment;

FIG. 2 is a perspective view of the vehicle seat showing a seatback frame;

FIG. 3 is a schematic exploded view of a right panel structure of a right seatback;

FIG. 4 is an exploded view of a right seatback frame;

FIG. 5 is a perspective view of a main part of the right seatback frame;

FIG. 6 is a perspective view of a latching device as viewed from the right rear;

FIG. 7 is a right side view of the latching device;

FIG. 8 is a right side view of the latching device with a movement restraining part removed; and

FIG. 9 is a perspective view of a reinforcement plate and the movement restraining part.

### DETAILED DESCRIPTION OF THE INVENTION

In the following, an embodiment in which the present invention is applied to a car seat 1 which is an example of a vehicle seat will be described with reference to the drawings.

The car seat 1 in the embodiment is a three-seater rear seat installed in the second row of an automobile. In the following, based on the traveling direction of the automobile, the three seats 2 (2R, 2C, 2L) of the car seat 1 will be referred to as the right seat 2R, the center seat 2C, and the left seat 2L. The center seat 2C is disposed at the center in the width direction of the automobile, and the right seat 2R and the left seat 2L are side seats disposed on both sides of the center seat 2C. When they are collectively referred to or when they are not distinguished from each other, they may be simply referred to as the seats 2.

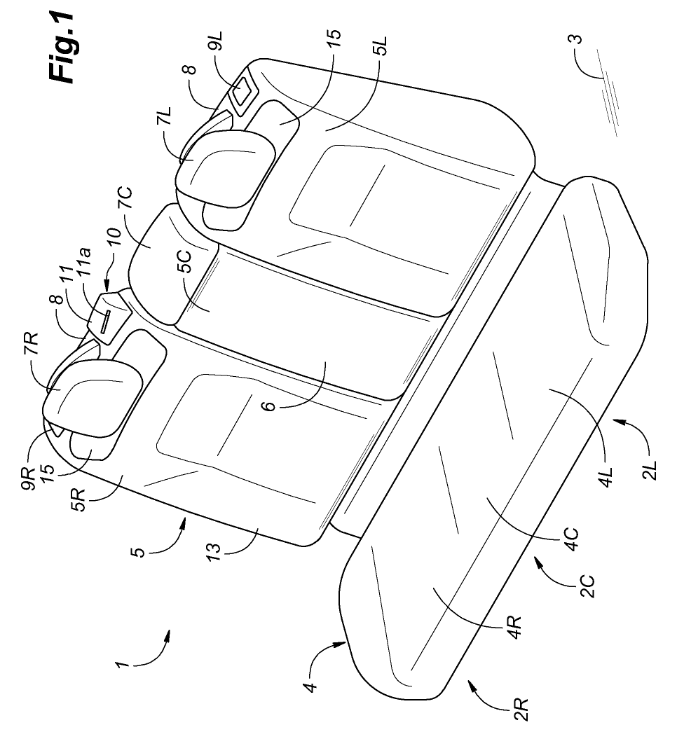

FIG. 1 is a perspective view of a car seat 1 according to an embodiment. As shown in FIG. 1, the car seat 1 includes a seat cushion 4 supported on a body of the automobile (hereinafter referred to as the vehicle body 3) to support the occupant's buttocks from below and a seatback 5 for supporting the occupant's back from the rear. The seat cushion 4 is a component manufactured commonly for the three seats 2 and includes a right cushion part 4R for the right seat 2R, a center cushion part 4C for the center seat 2C, and a left cushion part 4L for the left seat 2L. The seat cushion 4 is fixed to the floor which is a part of the vehicle body 3.

The seatback 5 is a two-piece type divided between left and right so that the ratio of the right part to the left part is 6/4, and includes a right seatback 5R and a left seatback 5L. The right seatback 5R integrally includes a right seatback part for the right seat 2R and a center seatback part 5C for the center seat 2C. Namely, the right seatback 5R is formed commonly for the right seat 2R and the center seat 2C. The left seatback 5L is configured as a left seatback part for the left seat 2L. The right seatback 5R and the left seatback 5L are pivotably supported.

The right seatback 5R and the left seatback 5L are configured to pivot between a standing position for seating as shown in FIG. 1 and a folded position which is pivoted forward from the standing position. When in the standing position, upper portions of the right seatback 5R and the left seatback 5L are fixed to the vehicle body 3 so that they do not pivot forward. When the right seatback 5R and the left seatback 5L are in the folded position, the space above the right seatback 5R and the left seatback 5L may be used as a cargo room extension that extends the cargo room provided behind the seats 2 forward.

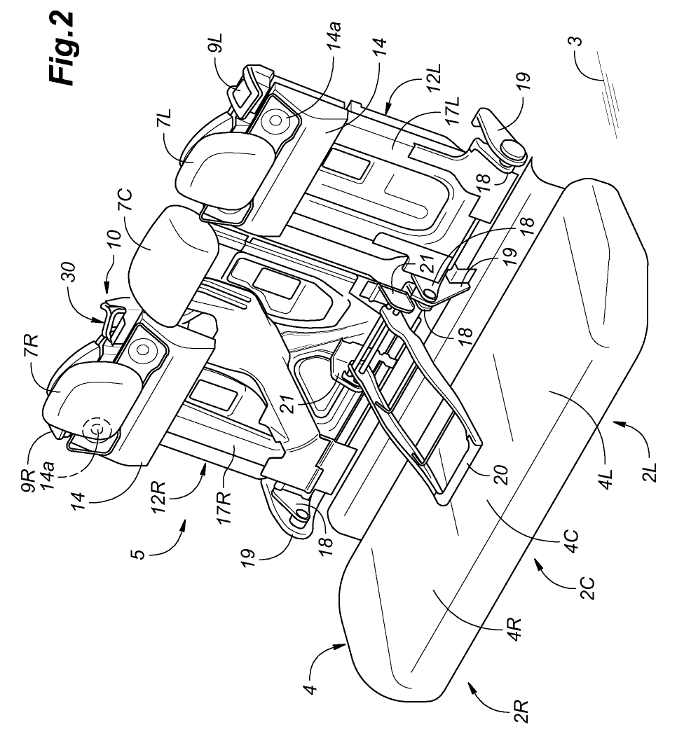

In a front portion of the center seatback part 5C of the right seatback 5R, an accommodation recess in which an armrest 6 is disposed is formed to be recessed rearward. The armrest 6 is disposed in the accommodation recess and is supported at the lower portion thereof on the right seatback 5R to be pivotable about a rotation axis extending laterally. The armrest 6 includes a base end portion supported on the seatback 5 and a tip end portion remote from the base end portion, and is configured to pivot between an accommodation position (the position in FIG. 1) in which the tip end portion is positioned in an upper portion of the accommodation recess and a use position (see FIG. 2) in which the tip end portion is positioned in front of the base end portion. The armrest 6 constitutes substantially the whole front surface of the center seatback part 5C.

An upper portion of the right seatback 5R is provided with a right headrest 7R for the right seat 2R and a center headrest 7C for the center seat 2C so that their vertical positions can be changed. An upper portion of the left seatback 5L is provided with a left headrest 7L for the left seat 2L so that its vertical position thereof can be changed. FIG. 1 shows a state in which each headrest is in the lowermost position. In this state, the right headrest 7R and the left headrest 7L protrude upward from the upper ends of the corresponding seatbacks 5 relatively largely. The center headrest 7C is configured not to protrude from the upper end of the right seatback 5R.

The upper portions of the right seatback 5R and the left seatback 5L are provided with an exterior cover member 8 made of resin. On a part of the upper end of the right seatback 5R on the right side of the right headrest 7R, a right seatback release lever 9R for releasing the fixation of the right seatback 5R in the standing position to the vehicle body 3 is provided. On a part of the upper end of the left seatback 5L on the left side of the left headrest 7L, a left seatback release lever 9L for releasing the fixation of the left seatback 5L in the standing position to the vehicle body 3 is provided.

On a part of the upper end of the right seatback 5R on the left side of the right headrest 7R, a belt garnish 11 which is an exterior cover made of resin and forming a belt outlet 11a of a seat belt device 10 for the center seat 2C is provided. The configuration of the seat belt device 10 will be described later.

A belt outlet of a seat belt device for the right seat 2R is formed in an interior resin component (not shown in the drawings) disposed on the right side of the right seatback 5R and functioning as a bolster. A belt retractor for the right seat 2R is disposed inside the interior resin component and is fixed to the vehicle body 3 via a bracket. The configuration related to the seat belt for the left seat 2L differs from that for the right seat 2R in that they are bilaterally symmetrical with other, and is otherwise the same.

FIG. 2 is a perspective view of the car seat 1 showing a frame of the seatback 5 (hereinafter referred to as the seatback frame 12 (12R, 12L)). As shown in FIG. 2, the seatback 5 includes a seatback frame 12, a pad (not shown in the drawings) having flexibility and supported on the seatback frame 12, and a skin member 13 (see FIG. 1) covering the pad. The pad is preferably formed of urethane foam, for example. The skin member 13 is preferably formed of a flexible sheet material, such as artificial or synthetic leather, natural leather, fabric, for example.

The upper portions of the right seatback 5R and the left seatback 5L are internally provided with speaker devices 14. Each speaker device 14 includes a pair of speakers 14a disposed on both sides of the right headrest 7R or the left headrest 7L corresponding thereto. Front surfaces of the pair of speaker devices 14 are provided with speaker grilles 15 (FIG. 1).

A part of the seatback frame 12 for the right seatback 5R (hereinafter referred to as the right seatback frame 12R) is formed commonly for the center seat 2C and the right seat 2R, which is disposed on the right side of the center seat 2C. The right seatback frame 12R includes a right panel structure 17R having a rectangular plate shape and left and right pivot connection parts 18 integrally provided on both side portions (more specifically, on right and left ends) of a lower part of the right panel structure 17R. The left and right pivot connection parts 18 are pivotably supported by vehicle body-side support members 19 fixed to the vehicle body 3, whereby the right seatback frame 12R is supported to be pivotable about an axis extending in the vehicle width direction.

A part of the seatback frame 12 for the left seatback 5L (hereinafter referred to as the left seatback frame 12L) includes a left panel structure 17L having a vertically elongated rectangular plate shape and left and right pivot connection parts 18 integrally provided on right and left ends of a lower part of the left panel structure 17L. The left and right pivot connection parts 18 are pivotably supported by vehicle body-side support members 19 fixed to the vehicle body 3, whereby the left seatback frame 12L is supported to be pivotable about an axis extending in the vehicle width direction. The left pivot connection part 18 of the right seatback frame 12R and the right pivot connection part 18 of the left seatback frame 12L are arranged to interpose one vehicle body-side support member 19 therebetween and are supported by the common vehicle body-side support member 19.

A lower portion of a part of the right seatback frame 12R constituting the center seatback part 5C is integrally provided with left and right armrest brackets 21 to support the frame of the armrest 6 (hereinafter referred to as the armrest frame 20). The armrest frame 20 has an elongated rectangular frame shape and is supported, at the lower end or the rear end thereof, by the left and right armrest brackets 21 to be pivotable about an axis extending in the vehicle width direction.

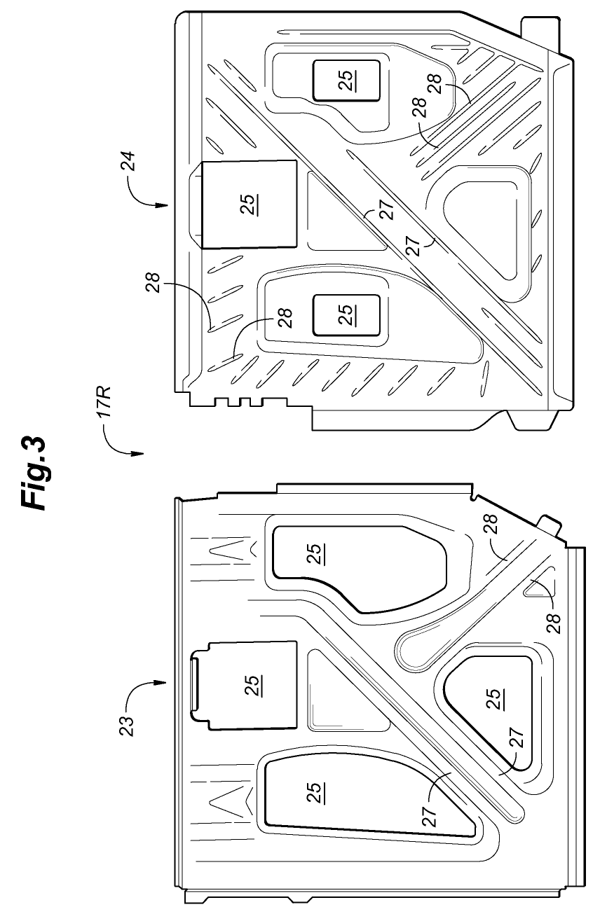

FIG. 3 is a schematic exploded view of the right panel structure 17R of the right seatback 5R. As shown in FIG. 3, the right panel structure 17R includes, as main components thereof, a front panel 23 and a rear panel 24 which are made of steel and are joined to each other in an overlapping state to constitute the structural body. The front panel 23 and the rear panel 24 have outer contours with substantially the same size. The front panel 23 and the rear panel 24 may be joined to each other by laser welding, gas welding, spot welding, etc., for example. In the following, unless otherwise mentioned, "being joined" means that the joining is achieved by any of these.

The rear panel 24 is provided with relatively small three openings 25 at the center of an upper portion and in left and right parts of an intermediate position in the height direction. The rear panel 24 has two oblique large ribs 27 continuously extending from the right lower portion to the left upper portion incline in an inclined manner. The right upper portion and the left lower portion of the rear panel 24 are formed with multiple oblique small ribs 28 which are inclined in the direction opposite to the inclination direction of the oblique large ribs 27. The oblique large ribs 27 and the oblique small ribs 28 are formed to be convex forward by press-forming a steel plate.

The front panel 23 is provided with relatively large four openings 25 at the center of an upper portion, at the center of a lower portion, and in left and right parts of an intermediate position in the height direction. The front panel 23 has two oblique large ribs 27 continuously extending from the right lower portion to the left upper portion in an inclined manner. The left lower portion of the front panel 23 is formed with two oblique small ribs 28 which are inclined in the direction opposite to the inclination direction of the oblique large ribs 27. The oblique large ribs 27 and the oblique small ribs 28 are formed to be convex forward by press-forming a steel plate.

In the upper center opening 25, a seat belt retractor of the seat belt device 10 for winding up the belt is disposed (the seat belt retractor and the belt are not shown in the drawings). The seat belt retractor is mounted to the right panel structure 17R so as to be received in the opening 25 via a support bracket disposed on a rear portion of the right panel structure 17R. On a part of an upper portion of the right panel structure 17R aligned in the width direction of the seatback frame 12 with the upper center opening 25, in which the seat belt retractor is disposed, a belt guide mechanism 30 (see FIG. 2) for guiding the seat belt is provided. The belt guide mechanism 30 is disposed in a position offset toward the right seat 2R from the seat center of the center seat 2C on which the belt is to be fastened.

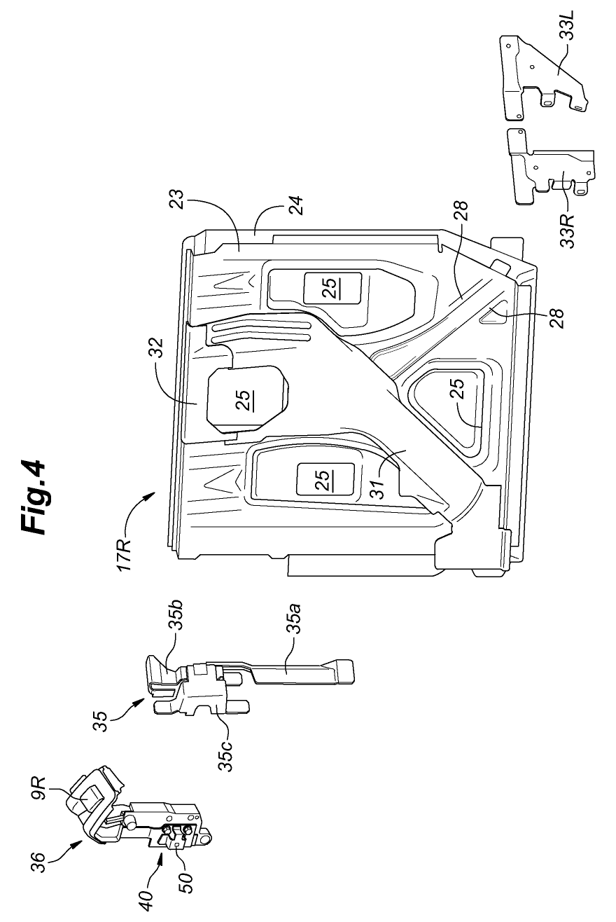

FIG. 4 is an exploded view of the right seatback frame12R. As shown in FIG. 4, the right panel structure 17R is further provided with a first reinforcement plate 31 and a second reinforcement plate 32 as reinforcement members in addition to the front panel 23 and the rear panel 24. The first reinforcement plate 31 has a size and a shape to cover the oblique large ribs 27 of the front panel 23 and to surround a lower portion of the opening 25 at the center of the upper portion of the front panel 23. Namely, the first reinforcement plate 31 is attached to the right panel structure 17R so as to extend from one side portion of the right panel structure 17R (more specifically, from the vicinity of the pivot connection part 18 (FIG. 2) at the right end of the lower portion of the right panel structure 17R) to the other side portion (more specifically, the left upper portion) of the right panel structure 17R. The first reinforcement plate 31 is attached to the front surface of the front panel 23. The second reinforcement plate 32 has a size and a shape to surround an upper part of the opening 25 at the center of the upper portion of the front panel 23 and, in cooperation with the first reinforcement plate 31, to surround the entire circumference of the opening 25. The second reinforcement plate 32 is attached to the front surface of the front panel 23 and the front surface of the first reinforcement plate 31.

Further, a speaker mounting bracket 33 (33R, 33L) for mounting the speaker device 14 to the right panel structure 17R is fixed to the right panel structure 17R. The speaker mounting brackets 33 is composed of a right speaker mounting bracket 33R formed of a steel plate and supporting a right side part of the speaker device 14 and a left speaker mounting bracket 33L formed of a steel plate and supporting a left side part of the speaker device 14. In another embodiment, the speaker mounting bracket 33 may consist of a single steel plate or may be a sub-component configured by assembling multiple steel plates in advance.

The right seatback frame 12R is provided with a bracket sub-component 35 and a lock unit 36 in addition to the right panel structure 17R. The bracket sub-component 35 is a mounting member for mounting the lock unit 36 to the right panel structure 17R and is a sub-assembly configured by assembling, in advance, multiple press-formed steel plate members 35a, 35b, and 35c. The lock unit 36 is a unit in which a lock device (later-described latching device 40) for fixing the right seatback 5R in a predetermined position and an unlock device for releasing the lock of the lock device are integrally assembled. The right seatback release lever 9R mentioned above is a part built in the unlock device.

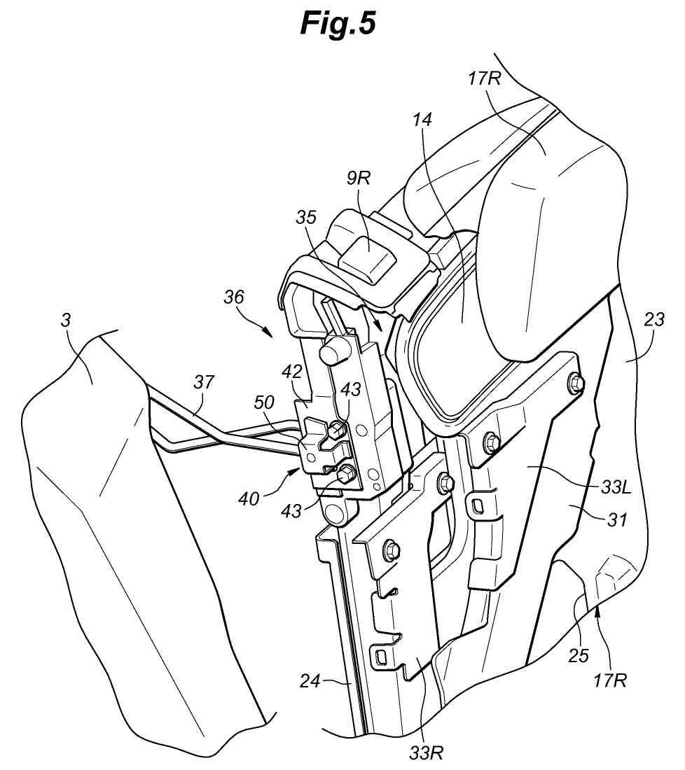

FIG. 5 is a perspective view of a main part of the right seatback frame 12R. As shown in FIG. 4 and FIG. 5, the bracket sub-component 35 is joined to the right end of the right panel structure 17R by laser welding. The bracket sub-component 35 forms a part of the right seatback frame 12R by being joined to the right panel structure 17R and is a frame member. Then, the left and right speaker mounting brackets 33L and 33R are attached to the right panel structure 17R, and the lock unit 36 is attached to the bracket sub-component 35. The lock unit 36 is a device for fixing the right seatback 5R in a predetermined position and is provided with a latching device 40 configured to lock or unlock by engaging with or disengaging from an engaged part 37a, which extends in the vehicle width direction, of the striker 37 fixed to the vehicle body 3.

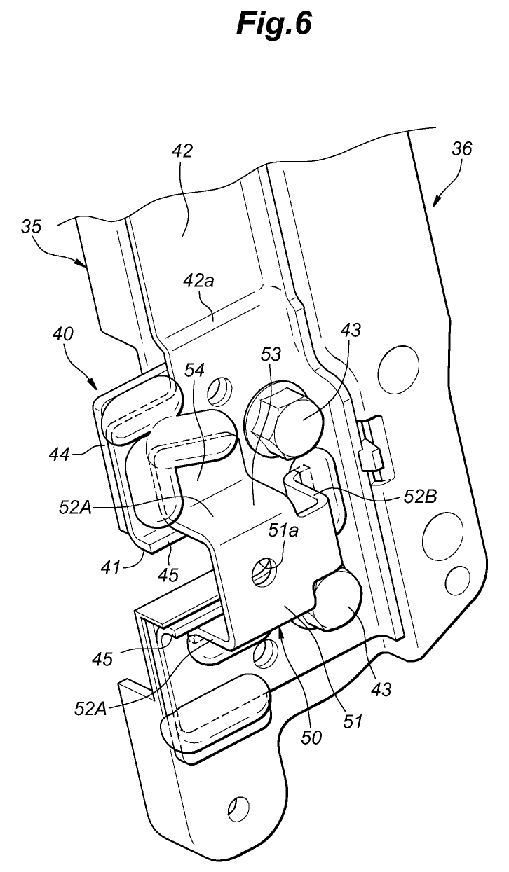

FIG. 6 is a perspective view of the latching device 40 as viewed from the right rear. As shown in FIG. 5 and FIG. 6, the latching device 40 includes a base member 42 formed with an entry groove 41 that the engaged part 37a of the striker 37 can enter. The base member 42 is a product obtained by press-forming a steel plate and has a rectangular shape which is elongated vertically when the right seatback 5R is in the standing position and is elongated in the front-rear direction when the right seatback 5R is in the folded position. The base member 42 extends along the right panel structure 17R and when the right seatback 5R is in the standing position, it extends substantially in the up-down direction while leaning rearward.

The base member 42 is fixed to the right panel structure 17R via the bracket sub-component 35. Specifically, the base member 42 is fixed to the bracket sub-component 35 by multiple base fixing parts 43. In the present embodiment, the base member 42 is fixed to the bracket sub-component 35 by two base fixing parts 43 arranged substantially vertically. The base fixing parts 43 may be composed of fastening members such as bolts and nuts, rivets, or the like, for example, or may be composed of engagement claws, welded parts, or the like.

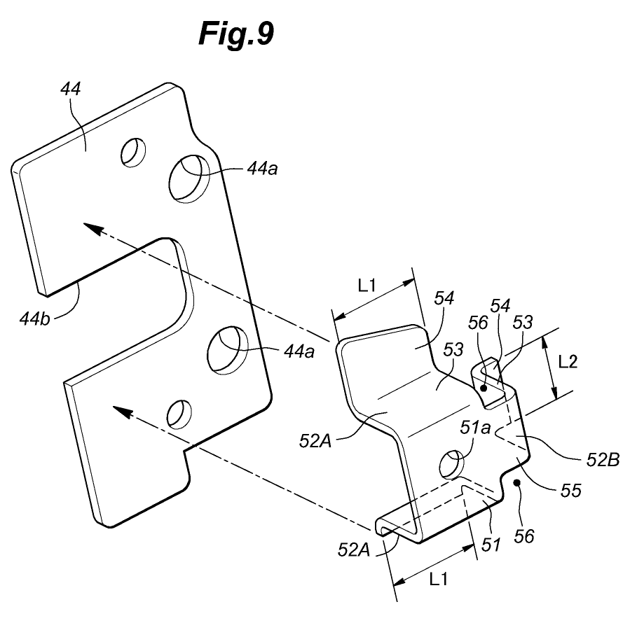

At a part of the base member 42 where the two base fixing parts 43 are provided, a reinforcement plate 44 (see FIG. 9) is interposed between the base member 42 and the bracket sub-component 35. Thereby, the section modulus of the joining part between the base member 42 and the bracket sub-component 35 is increased, and the stiffness of this part is improved.

The entry groove 41 extends along a tangential direction of a virtual circle having a center on the pivot axis of the right seatback 5R (the lower end of the right seatback 5R) and passing the entry groove 41. An edge part of the base member 42 defining the entry groove 41 is formed with a flange 45 that is bent outward in the vehicle width direction. When the right seatback 5R is in the standing position, the entry groove 41 extends substantially in the front-rear direction and is opened at the rear edge of the base member 42. In the following, description will be continued based on the state in which the latching device 40 is functioning, namely, the state in which the latching device 40 engages with the striker 37 and the right seatback 5R is in the standing position.

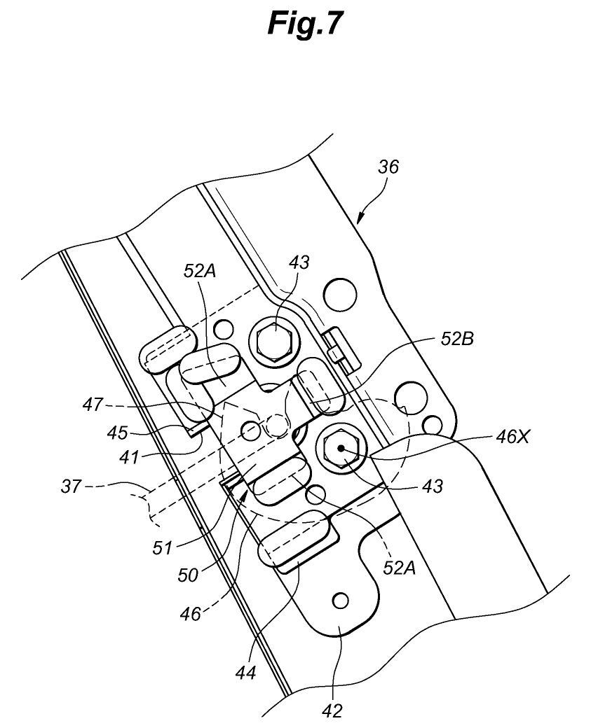

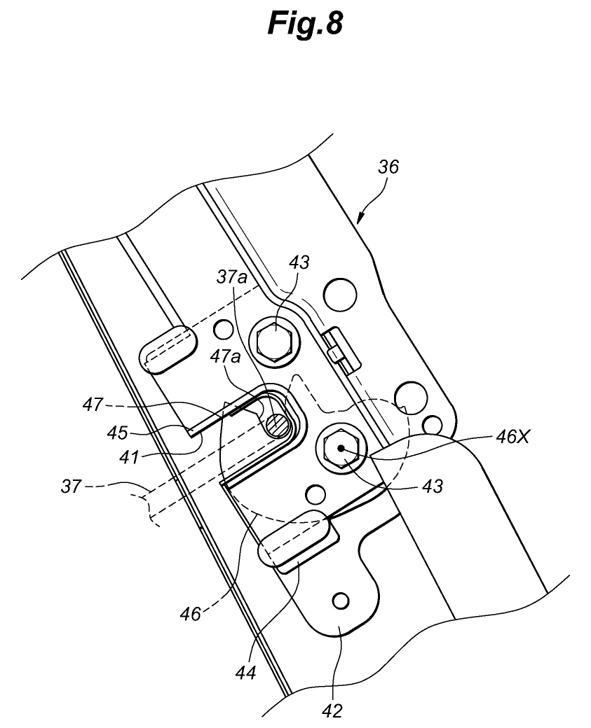

FIG. 7 is a right side view of the latching device 40, and FIG. 8 is a right side view of the latching device 40 with a later-described movement restraining part removed. As shown in FIG. 8, the latching device 40 includes a latch 46 supported on the base member 42 to be pivotable about a pivot axis 46X extending in the vehicle width direction. The latch 46 is pivotably supported by the lower base fixing part 43, and the pivot axis 46X thereof is positioned at the center of the lower base fixing part 43. The latching device 40 has a known configuration provided with a rachet, a lever member, a rod, and a spring member not shown in the drawings. The latch 46 is formed by blanking a thick metal plate and has an engagement key part 47 capable of engaging with the striker 37. In the state in which the engagement key part 47 engages with the engaged part 37a of the striker 37, the engagement key part 47 forms a striker receiving groove 47a for receiving the engaged part 37a on the side of the pivot axis 46X of the latch 46. The striker receiving groove 47a extends substantially perpendicularly to the extension direction of the entry groove 41.

When the right seatback release lever 9R (FIG. 5) is pulled upward, the latch 46 pivots counterclockwise in the drawing, and the engagement key part 47 exits the entry groove 41, allowing the engaged part 37a of the striker 37 to get out of the entry groove 41. Thereby, the right seatback 5R becomes able to pivot from the standing position to the folded position.

In this way, the latching device 40 locks or unlocks by engaging with or disengaging from the striker 37.

As shown in FIG. 6 and FIG. 7, a movement restraining part 50 is provided on the right side surface of the base member 42. The movement restraining part 50 restrains rightward movement of the striker 37 relative to the latch 46. The movement restraining part 50 is formed in a three-dimensional shape by bending a thick metal plate blanked in a predetermined shape. The movement restraining part 50 includes a main body 51 disposed to the right of the entry groove 41 and three fixing parts 52 (52A, 52A, 52B) extending from the main body 51 toward the base member 42 and fixed to the base member 42.

The main body 51 extends in parallel with the base member 42 and restricts the movement of the striker 37 by contacting the striker 37. At the center of the main body 51, a circular through hole 51a is formed. The fixing parts 52 include a pair of first fixing parts 52A extending in parallel with the extension direction of the entry groove 41 and facing each other and a second fixing part 52B extending in a direction intersecting the extension direction of the entry groove 41. The upper one of the first fixing parts 52A is disposed to extend in the front-rear direction along the upper edge of the entry groove 41, and the lower one of the first fixing part 52A is disposed to extend in the front-rear direction along the lower edge of the entry groove 41. The second fixing part 52B is disposed to extend in the up-down direction along the end (front end) of the entry groove 41.

FIG. 9 is a perspective view of the reinforcement plate 44 and the movement restraining part 50. As shown in FIG. 6 and FIG. 9, each fixing part 52 includes a wall portion 53 extending from the main body 51 toward the base member 42 and a contact portion 54 extending outward (in the direction away from the entry groove 41) from the tip of the wall portion 53 and contacting the base member 42. The upper and lower first fixing parts 52A have the same width (the length L1 of the first fixing part 52A in the extension direction of the entry groove 41) which is greater than the width of the second fixing part 52B (the length L2 of the second fixing part 52B in the direction intersecting the extension direction of the entry groove 41). The contact portion 54 of the upper first fixing part 52A has a longer extension length than the contact portion 54 of the lower first fixing part 52A. The contact portion 54 of the lower first fixing part 52A has a rectangular shape. In contrast, the contact portion 54 of the upper first fixing part 52A has a trapezoidal shape in which the extension length from the wall portion 53 is different on the left side and the right side. The extension length of the wall portion 53 is short on the side of the second fixing part 52B and long on the side of the open end of the entry groove 41.

In addition to the wall portion 53 and the contact portion 54, the second fixing part 52B includes an extension part 55 that extends from the main body 51 along the main body 51 so as to extend the main body 51. Thereby, the wall portion 53 of the second fixing part 52B is disposed in a position spaced from the main body 51, and a gap 56 is formed between the wall portion 53 of the second fixing part 52B and the wall portion 53 of each of the first fixing parts 52A.

The reinforcement plate 44 has a vertical dimension smaller than that of the base member 42 and has a contour substantially corresponding to the contour of a lower portion of the base member 42. The reinforcement plate 44 has two through holes 44a in positions corresponding to the two base fixing parts 43 and a cutout 44b having the same shape as the entry groove 41 in a position corresponding to the entry groove 41. The base member 42 has a step 42a having a height corresponding to the thickness of the reinforcement plate 44 at a position above the part where the reinforcement plate 44 is interposed and is fastened to the bracket sub-component 35 by the two base fixing parts 43 together with the reinforcement plate 44.

Each fixing part 52 is positioned by placing the tip of the wall portion 53 along the flange 45 of the base member 42 and is fixed to the base member 42 by joining the contact portion 54 to the base member 42. Specifically, the contact portion 54 of each of the lower first fixing part 52A and the second fixing part 52B is fixed to the base member 42 by welding along the edge of the extension end thereof. The upper first fixing part 52A is fixed to the base member 42 by welding along the edge of the extension end thereof and along the rear edge thereof (namely, the edge on the side opposite from the second fixing part 52B).

As shown in FIG. 1 and FIG. 2, the seat belt device 10 for the center seat 2C is mounted on the right seatback frame 12R. Therefore, when the car collides head-on, the load of the occupant of the center seat 2C acts on the central part of the right seatback frame 12R in the width direction via the seat belt device 10. The right seatback frame 12R is supported on the vehicle body 3 to be pivotable about an axis extending in the width direction at the two pivot connection parts 18 provided at the lower end.

On the other hand, as shown in FIG. 4 and FIG. 5, an upper portion of the right seatback frame 12R is fixed to the vehicle body 3 by the latching device 40 provided at the right end thereof and engaging with the striker 37. Therefore, when the car collides head-on, the right seatback frame 12R receives a forward load while the right end of the upper portion is fixed to the vehicle body 3, and as a result, twisting occurs. Due to this twisting, the latching device 40 moves leftward relative to the striker 37. In other words, the striker 37 undergoes a rightward relative movement in the latching device 40.

In the present embodiment, as shown in FIG. 5 and FIG. 6, the latching device 40 includes the movement restraining part 50 provided on the base member 42. As shown in FIG. 7 , the movement restraining part 50 is disposed across the entry groove 41 in side view. Therefore, when the latch 46 engaging with the striker 37 moves relative to the striker 37, the striker 37 comes into contact with the movement restraining part 50 crossing the entry groove 41. Thereby, the movement of the striker 37 relative to the latch 46 is restrained by the movement restraining part 50.

In the side view of FIG. 7, the movement restraining part 50 is disposed to cross the engagement part between the engagement key part 47 of the latch 46 and the striker 37 (namely, the engaged part 37a of the striker 37 received in the striker receiving groove 47a defined by the engagement key part 47). Therefore, when the latch 46 engaging with the striker 37 moves relative to the striker 37, the striker 37 reliably comes into contact with the movement restraining part crossing the engagement part 50. Thereby, the relative movement between the latch 46 and the striker 37 is restrained.

As shown in FIG. 6 and FIG. 7, the movement restraining part 50 is fixed to the base member 42 by the pair of first fixing parts 52A extending in parallel with the extension direction of the entry groove 41 and facing each other and the second fixing part 52B extending in a direction intersecting the extension direction of the entry groove 41. Thereby, the movement restraining part 50 exhibits high stiffness against the load during the relative movement of the striker 37.

As shown in FIG. 6 and FIG. 9, a gap 56 is formed between each of the first fixing parts 52a and the second fixing part 52b, and the gap 56 is configured such that the latch 46 is viewable through the gap 56. Thereby, the state of the latch 46 with respect to the striker 37 (engaged state or disengaged state) can be visually recognized.

As shown in FIG. 7 and FIG. 9, the length L1 of each of the first fixing parts 52A in the extension direction thereof is longer than the length L2 of the second fixing part 52B in the extension direction thereof. Thereby, the stiffness of each of the first fixing parts 52A which are at positions vertically sandwiching the striker 37 engaged by the latch 46 can be made high compared to the stiffness of the second fixing part 52B. Thus, the relative movement between the latch 46 and the striker 37 is more reliably restrained.

As shown in FIG. 6 and FIG. 7, the base member 42 is provided with the multiple base fixing parts 43 for fixing the base member 42 to the bracket sub-component 35 serving as a frame member. Further, the second fixing part 52B of the movement restraining part 50 is disposed between the multiple base fixing parts 43 and is fixed to a part of the base member 42. Thereby, the support stiffness of the second fixing part 52B is improved.

As shown in FIG. 6, the base member 42 is provided with a flange 45 extending along the edge of the entry groove 41. Also, the movement restraining part 50 is provided with the wall portion 53 along the flange 45. Thereby, the stiffness of the edge part of the entry groove 41 of the base member 42 is increased by the presence of the flange 45, and moreover, the stiffness of the movement restraining part 50 is increased by the presence of the wall portion 53 along the flange 45.

As shown in FIG. 6 and FIG. 7 , the base member 42 is provided with the two base fixing parts 43 for fixing the base member 42 to the bracket sub-component 35 serving as a frame member. Further, one of the first fixing parts 52A is disposed to be aligned with one of the base fixing parts 43 in the extension direction of the entry groove 41, and the other of the first fixing part 52A is disposed to be aligned with the other of the base fixing parts 43 in the extension direction of the entry groove 41. Thereby, since each of the first fixing parts 52A is disposed to be aligned with the corresponding base fixing part 43 in the extension direction of the entry groove 41, the support stiffness of the both first fixing parts 52A is improved.

As shown in FIG. 1 and FIG. 2, the car seat 1 according to the present embodiment includes the right seatback 5R supported on the vehicle body 3 to be pivotable about the pivot axis extending in the vehicle width direction and the latching device 40. As shown in FIG. 4 and FIG. 5, the latching device 40 is disposed on only one of the side portions of the right seatback 5R. Further, as shown in FIG. 7 and FIG. 8, the striker 37 is fixed to the vehicle body 3. Thereby, the car seat 1 can restrain the relative movement between the latch 46 and the striker 37.

When a large load is applied to the seatback 5, the latching device 40 moves toward the center of the seatback 5 in the width direction, and the striker 37 undergoes a relative movement outward in the width direction, namely, to the right. In the present embodiment, the movement restraining part 50 is disposed on the outer side of the base member 42 in the width direction, namely, on the right side of the base member 42. Therefore, the striker 37 undergoing the relative movement outward in the width direction comes into contact with the movement restraining part 50, whereby the movement of the striker 37 relative to the latch 46 is restrained by the movement restraining part 50.

Concrete embodiments have been described in the foregoing, but the present invention can be modified in various ways without being limited to the above embodiments.

In the above embodiment, since the seat belt device 10 for the center seat 2C is provided on the right panel structure 17R of the right seatback 5R, the movement restraining part 50 is attached to the latching device 40 of the right seatback 5R. In a case where the seat belt device 10 for the center seat 2C is provided on the left panel structure 17L of the left seatback 5L, the movement restraining part 50 is preferably attached to the latching device 40 of the left seatback 5L.

The movement restraining part 50 in the above embodiment is provided with three fixing parts 52, but may be provided with only one pair of first fixing parts 52A and may be fixed to the base member 42 at two points. Also, though the movement restraining part 50 is formed of a metal plate separate from the base member 42 and is joined to the base member 42, in another embodiment, the movement restraining part 50 may be formed integrally with the base member 42.

1. A latching device configured to lock or unlock by engaging with or disengaging from a striker, the latching device comprising:
a base member having an entry groove that the striker can enter;
a latch pivotably supported on the base member and having an engagement key part configured to engage with the striker that has entered the entry groove; and
a movement restraining part provided on the base member and disposed across the entry groove.

2. The latching device according to claim 1, wherein the movement restraining part is disposed to cross an engagement part between the engagement key part of the latch and the striker.

3. The latching device according to claim 1, wherein the movement restraining part is fixed to the base member by a pair of first fixing parts extending in parallel with an extension direction of the entry groove and facing each other and a second fixing part extending in a direction intersecting the extension direction of the entry groove.

4. The latching device according to claim 3, wherein a gap is formed between each of the first fixing parts and the second fixing part, and the gap is configured such that the latch is viewable from outside through the gap.

5. The latching device according to claim 3, wherein a length of each of the first fixing parts in an extension direction thereof is longer than a length of the second fixing part in an extension direction thereof.

6. The latching device according to claim 3, wherein the base member is provided with multiple base fixing parts for fixing the base member to a frame member, and
the second fixing part of the movement restraining part is disposed between the multiple base fixing parts.

7. The latching device according to claim 1, wherein the base member is provided with a flange along an edge of the entry groove, and
the movement restraining part is provided with a wall portion along the flange.

8. The latching device according to claim 3, wherein the base member is provided with two base fixing parts for fixing the base member to a frame member,
one of the first fixing parts is disposed to be aligned with one of the base fixing parts in the extension direction of the entry groove, and
another of the first fixing parts is disposed to be aligned with another of the base fixing parts in the extension direction of the entry groove.

9. A vehicle seat, comprising:
a seat cushion provided on a body of a vehicle;
a seatback supported on the body to be pivotable about a pivot axis extending in a width direction of the vehicle; and
the latching device according to claim 1,
wherein the latching device is disposed on one of side portions of the seatback and the striker is fixed to the body.

10. The vehicle seat according to claim 9, wherein the movement restraining part is disposed on an outer side of the base member in the width direction.
